(19) United States
(12) Patent Application Publication
(10) Pub. No.: US 2026/0046408 A1
(43) Pub. Date: Feb. 12, 2026

(54) METHODS AND DEVICES ON TRANSFORM COEFFICIENT DEQUANTIZATION

(71) Applicant: BEIJING DAJIA INTERNET INFORMATION TECHNOLOGY CO., LTD., Beijing (CN)

(72) Inventors: Ning YAN, San Diego, CA (US); XIAOYU XIU, San Diego, CA (US); Che-Wei KUO, San Diego, CA (US); Wei CHEN, San Diego, CA (US); Hong-Jheng JHU, San Diego, CA (US); Changyue MA, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/363,422

(22) Filed: Oct. 20, 2025

Related U.S. Application Data
(63) Continuation of application No. PCT/US2024/026698, filed on Apr. 27, 2024.
(60) Provisional application No. 63/462,507, filed on Apr. 27, 2023.

(51) Int. Cl. H04N 19/126; H04N 19/136; H04N 19/176; H04N 19/184

(52) U.S. Cl. CPC H04N 19/126; H04N 19/136; H04N 19/176; H04N 19/184

(57) ABSTRACT

Methods for video decoding and encoding, and apparatuses are provided. In one video decoding method, a decoder may obtain a dequantization offset according to at least one of the following parameters: a transition state, a quantization parameter (QP), or a segment of magnitude of an original quantization index. Further, the decoder may obtain a quantization index based on the dequantization offset and the original quantization index. Moreover, the decoder may obtain a dequantized transform coefficient based on the quantization index.

### CROSS-REFERENCE TO RELATED APPLICATION

The present application is a Continuation Application of International Application No. PCT/US2024/026698, filed on Apr. 27, 2024, which is based upon and claims priority to U.S. Provisional Application No. 63/462,507, entitled “Methods and Devices on Transform Coefficient Dequantization,” filed on Apr. 27, 2023, both of which are incorporated by reference in their entireties for all purposes.

### TECHNICAL FIELD

The present disclosure is related to video coding and compression, and in particular but not limited to, methods and apparatus to improve the coding efficiency by improving the quantization techniques.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

The present disclosure provides examples of techniques relating to improving the coding efficiency by improving the quantization techniques.

According to a first aspect of the present disclosure, there is provided a method for video decoding. In the method, a decoder may obtain a dequantization offset according to at least one of following parameters: a transition state, a quantization parameter (QP), or a segment of magnitude of an original quantization index. Additionally, the decoder may obtain a quantization index based on the dequantization offset and the original quantization index. Furthermore, the decoder may obtain a dequantized transform coefficient based on the quantization index and obtain a reconstructed sample based on the dequantized transform coefficient.

According to a second aspect of the present disclosure, there is provided a method for video encoding. In the method, an encoder may obtain a dequantization offset according to at least one of following parameters: a transition state, a quantization parameter (QP), or a segment of magnitude of an original quantization index. Additionally, the encoder may obtain a quantization index based on the dequantization offset and the original quantization index. Furthermore, the encoder may obtain a dequantized transform coefficient based on the quantization index and obtain a reconstructed sample based on the dequantized transform coefficient.

According to a third aspect of the present disclosure, there is provided an apparatus for video decoding. The apparatus includes one or more processors; and a memory coupled to the one or more processors and configured to store instructions executable by the one or more processors, where the one or more processors, upon execution of the instructions, are configured to perform the method according to the first aspect.

According to a fourth aspect of the present disclosure, there is provided a non-transitory computer-readable storage medium for storing computer-executable instructions that, when executed by one or more computer processors, cause the one or more computer processors to perform the method according to the first aspect.

According to a fifth aspect of the present disclosure, there is provided an apparatus for video encoding. The apparatus includes one or more processors; and a memory coupled to the one or more processors and configured to store instructions executable by the one or more processors, where the one or more processors, upon execution of the instructions, are configured to perform the method according to the second aspect.

According to a sixth aspect of the present disclosure, there is provided a non-transitory computer-readable storage medium for storing computer-executable instructions that, when executed by one or more computer processors, cause the one or more computer processors to perform the method according to the second aspect.

According to a seventh aspect of the present disclosure, there is provided a non-transitory computer-readable storage medium for storing a bitstream to be decoded by the method according to the first aspect.

According to an eighth aspect of the present disclosure, there is provided a non-transitory computer-readable storage medium for storing a bitstream generated by the method according to the second aspect.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIG. 5 illustrates a diagram of the two scalar quantizers used in the approach of dependent quantization in accordance with some implementations of the present disclosure.

FIG. 6 illustrates the state transition and quantizer selection for the dependent quantization in accordance with some implementations of the present disclosure.

FIG. 7 illustrates the method of selecting the dequantization offset where blue circles represent the neighboring reconstructed samples and the orange circles represent the left and top boundary reconstructed samples with the current block in accordance with some implementations of the present disclosure.

FIG. 8 is a diagram illustrating a computing environment coupled with a user interface, according to some implementations of the present disclosure.

FIG. 9 is a flow chart illustrating a method for video decoding in accordance with some examples of the present disclosure.

FIG. 10 is a flow chart illustrating a method for video encoding corresponding to the method for video decoding as shown in FIG. 9 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

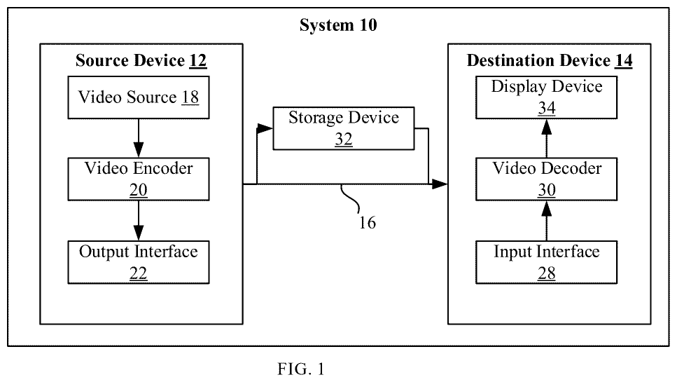

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

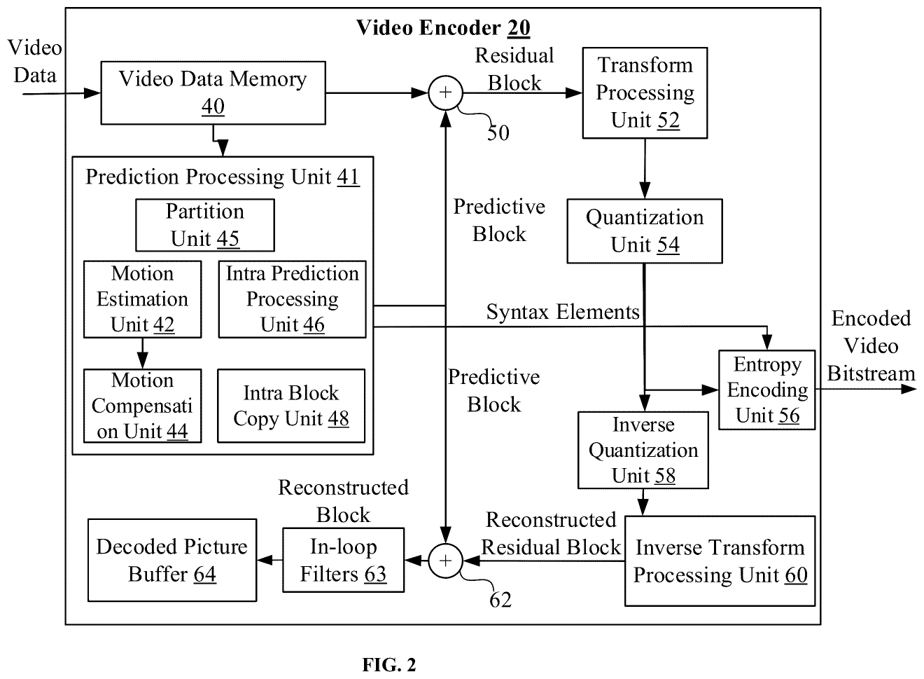

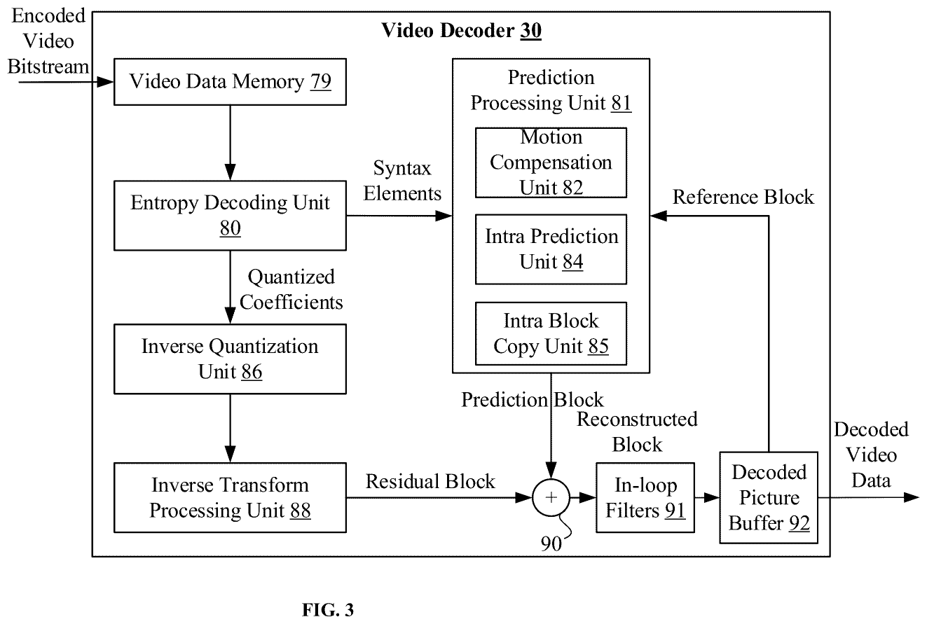

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

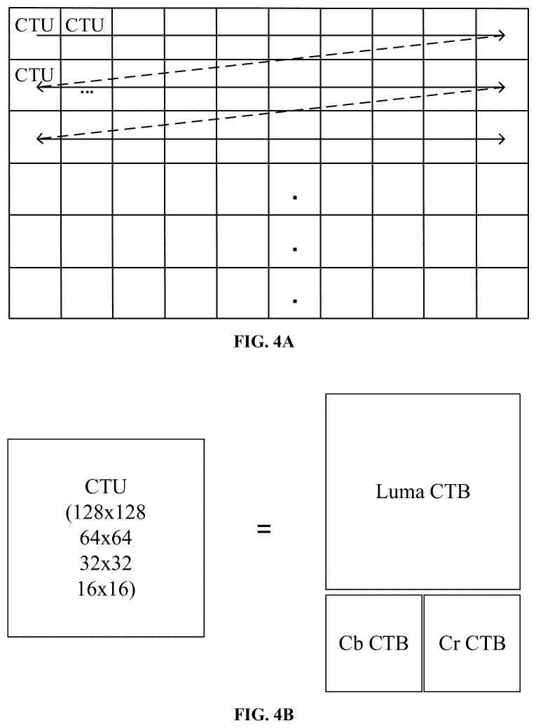

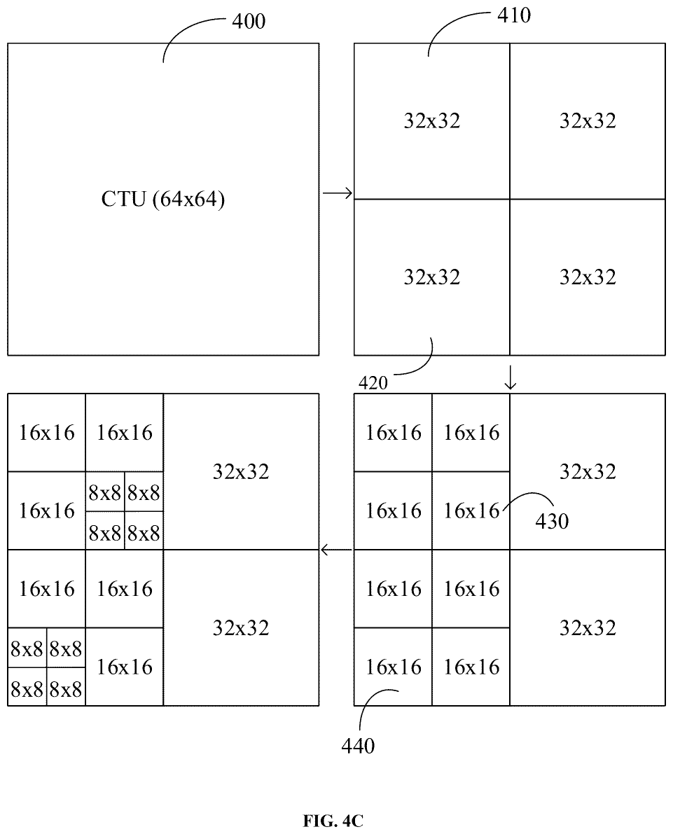

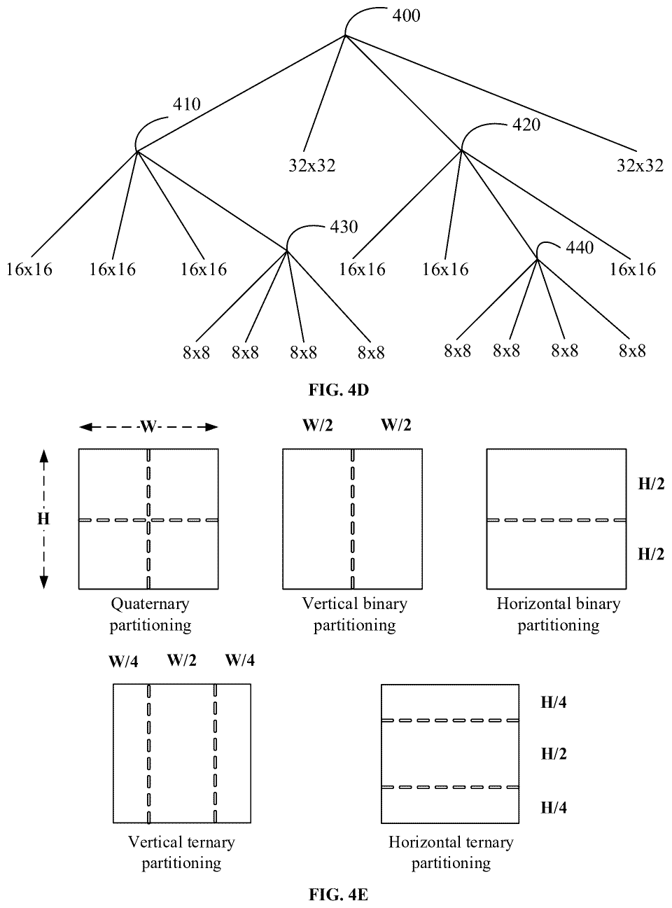

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

In this disclosure, transition state based dequantization offset method is provided to further improve the compression efficiency of the dequantization offset technique. Furthermore, QP-based dequantization offset method is provided to further improve the compression efficiency of the dequantization offset technique. Moreover, adaptive dequantization offset method is provided to further improve the compression efficiency of the dequantization offset technique.

### Quantization

Quantization is an irreversible mapping of input values to output values. For the specification in image and video coding standards, it is split into a non-normative encoder mapping of input samples to integer quantization indexes, which are also referred to as levels and are transmitted using entropy coding, and a normative decoder mapping of the quantization indexes to reconstructed values. The aim of quantization is to approximate the input values in a way that the bit rate required for transmitting the quantization indexes is minimized while a certain reconstruction error is not exceeded. In this section, quantization technique in the ECM and its improvement methods are reviewed. Similar as in AVC and HEVC, the quantizer design in VVC is based on scalar quantization with uniform reconstruction quantizers. In addition, VVC also includes two extensions that can improve coding efficiency at the cost of an increased encoder complexity.

### Uniform Reconstruction Quantization

In scalar quantization, the reconstructed value t′ₖ of each input coefficient (or sample) tₖ depends only on the associated quantization index qₖ. Uniform reconstruction quantizers (URQs) are a simple variant, in which the set of admissible reconstruction values is specified by a single parameter, called quantization step size Δₖ. The decoder operation is given by a simple scaling, t′ₖ=Δₖqₖ. Similar as previous ITU-T and ISO/IEC video coding standards, VVC supports quantization weighting matrices by which the quantization step size can be varied across the transform coefficients of a block. Conceptually, the step size for a coefficient tₖ is given by Δₖ=αₖΔ, where αₖ is a weighting factor that depends on the location of the coefficient tₖ inside the transform block and A is a quantization step size, which can be selected on a block basis among a pre-defined set of candidates. The chosen A is indicated by an integer value referred to as quantization parameter (QP). VVC uses an exponential relationship between Δ and QP, which was originally introduced in AVC. When neglecting rounding operations, the reconstruction of transform coefficients can be written as

$${t}_{k}^{′} = {α}_{k} {2}^{( Q P - 4 ) / 6} \cdot {2}^{B - 8} \cdot {q}_{k} \qquad ( 1 )$$

where B is the bit depth of the color component in bits per sample. The relationship Δ∝2^{B-8} ensures that a certain QP yields roughly the same subjective quality for all supported bit depths B.

For avoiding reconstruction mismatches, the entire VVC decoding process is specified using exact integer operations (similar to AVC and HEVC). In comparison to the idealized case with orthogonal transforms, the inverse transform for a W×H block includes an additional scaling by \sqrt{WH}·2^{B-15}. Consequently, the scaling in the decoder has to approximately generate reconstructed coefficients

$${t}_{k}^{′} = {α}_{k} \cdot {2}^{\frac{Q P - 4}{6} + B - 8} \cdot {2}^{15 - B} \cdot {( WH )}^{- 1 / 2} \cdot {q}_{k} \qquad ( 2 )$$

which are then used as input values to the inverse transform. With p=└QP/6┘+B−8, m=QP % 6,

$$β = ⌈ \frac{1}{2} {log}_{2} WH ⌉ ,$$

and γ=2β−log₂ WH, where ┌⋅┐ and └⋅┘ denote the ceiling and floor functions, respectively, and % denotes the modulus operator, the mapping from qₖ to

$${t}_{k}^{′}$$

can be rewritten according to

$${t}_{k}^{′} = ( 16 {α}_{k} ) \cdot ( {2}^{( 32 + 3 γ + m ) / 6} ) \cdot {2}^{p} \cdot {2}^{5 - β - B} \cdot {q}_{k} \qquad ( 3 )$$

Since both the width W and the height H of a transform block are integer powers of two, γ∈{0,1} is a binary parameter.

For obtaining a realization with integer operations, the two terms in parenthesis are rounded to integer values and the multiplication with 2^{5-β-B} is approximated by a bit shift. The VVC standard specifies the reconstruction according to

$${t}_{k}^{′} = ( {ω}_{k} . ( a [ γ ] [ m ] ≪ p ) \cdot {q}_{k} + ( ( 1 ≪ b ) ≫ 1 ) ) ≫ b \qquad ( 4 )$$

where << and >> denote bit shifts to the left and right (in two's complement arithmetic), respectively, and b=B+β−5. The 2×6 array a[γ][m] specifies integer values that approximate the terms 2^{(32+3γ+m)/}6. It is given by a={{40, 45, 51, 57, 64, 72}, {57, 64, 72, 80, 90, 102}}. The integer values ωₖ=round (16αₖ), with ωₖ∈[1; 255], are called scaling list. The scaling lists for different block types can be specified in a corresponding high-level data structure. If scaling lists are not used, the values ωₖ are inferred to be equal to 16, which corresponds to Δₖ=Δ.

In transform skip mode, no inverse transform is applied and, hence, no additional scaling factor has to be included in the reconstruction process of residual samples

$${r}_{k}^{′} .$$

Furthermore, the concept of scaling lists is not applicable. An integer realization of the reconstruction

$${r}_{k}^{′} = Δ {q}_{k}$$

is obtained by using (4) with ωₖ=16, γ=0, and b=10, which yields

$${r}_{k}^{′} = ( ( a [ 0 ] [ m ] ≪ ( p + 4 ) ) \cdot {q}_{k} + 5 \; 12 ) ≫ 10 \qquad ( 5 )$$

### Sign Data Hiding

Sign data hiding (SDH) is a technique that is already included in HEVC and hasn't been modified in the context of VVC. Consider a block of reconstructed transform coefficients

$$\{ {t}_{k}^{′} \}$$

that is represented by a corresponding block of quantization indexes {qₖ}, with

$${t}_{k}^{′} = {Δ}_{k} {q}_{k} .$$

The basic idea of SDH is to omit the coding of the sign for one nonzero index in {qₖ} and instead derive it from the parity of the sum of absolute values |qₖ|. In comparison to scalar quantization with the same step sizes Δₖ, SDH saves about 1 bit per block, which for suitably large blocks outweighs the average increase in distortion. But note that an encoder has to carefully select quantization indexes {qₖ} that obey the sign hiding condition in order to achieve coding efficiency improvements.

In HEVC and VVC, SDH is applied on the basis of so-called coefficient groups (CGs), which represent groups of successive levels qₖ in coding order; in most cases, they include 16 levels. If the difference between the scan indexes of the last and first nonzero level (in coding order) inside a CG is greater than 3, the sign for the last nonzero level of the CG is not coded but derived based on the sum of absolute values, Σ_{k∈CG}|qₖ|, where odd sums indicate negative values.

### Dependent Quantization

In addition, the same HEVC scalar quantization is used with a new concept called dependent scalar quantization. Dependent quantization (DQ) refers to an approach in which the set of admissible reconstruction values for a transform coefficient depends on the values of the transform coefficient levels that precede the current transform coefficient level in reconstruction order. The main effect of this approach is that, in comparison to conventional independent scalar quantization as used in HEVC, the admissible reconstruction vectors are packed denser in the N-dimensional vector space (N represents the number of transform coefficients in a transform block). That means, for a given average number of admissible reconstruction vectors per N-dimensional unit volume, the average distortion between an input vector and the closest reconstruction vector is reduced. The approach of dependent scalar quantization is realized by: (a) defining two scalar quantizers with different reconstruction levels and (b) defining a process for switching between the two scalar quantizers.

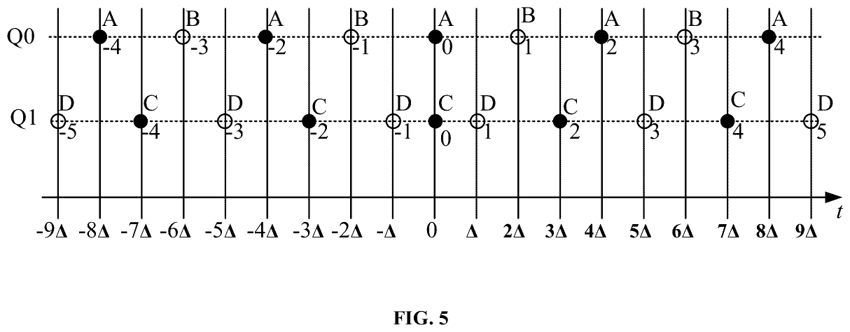

The two scalar quantizers used, denoted by Q0 and Q1, are illustrated in FIG. 5. The location of the available reconstruction levels is uniquely specified by a quantization step size Δ. The scalar quantizer used (Q0 or Q1) is not explicitly signalled in the bitstream. Instead, the quantizer used for a current transform coefficient is determined by the parities of the transform coefficient levels that precede the current transform coefficient in coding/reconstruction order.

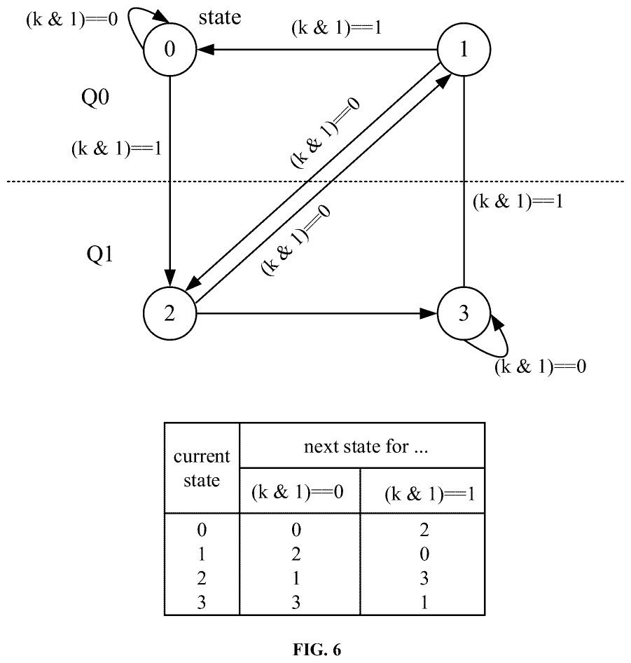

As illustrated in FIG. 6, the switching between the two scalar quantizers (Q0 and Q1) is realized via a state machine with four states. The state can take four different values: 0, 1, 2, 3. It is uniquely determined by the parities of the transform coefficient levels preceding the current transform coefficient in coding/reconstruction order. At the start of the inverse quantization for a transform block, the state is set equal to 0. The transform coefficients are reconstructed in scanning order (i.e., in the same order they are entropy decoded). After a current transform coefficient is reconstructed, the state is updated as shown in FIG. 6, where k denotes the value of the transform coefficient level.

In the ECM, the coding efficiency of trellis-coded quantization in VVC increased by increasing the number of quantization states (at the cost of a higher encoder complexity). Dependent quantization with 8 quantization states in addition to the current variant of dependent quantization with 4 quantization state is supported (JVET-Q0243).

For supporting both variants of dependent quantization (4 and 8 states) in a unified framework, the decoding process for the VVC variant of dependent quantization is re-written. The state transition table is modified from

$$QStateTransTable [ ] [ ] = \{ \{ 0 , 2 \} , \{ 2 , 0 \} , \{ 1 , 3 \} , \{ 3 , 1 \} \}$$

to

$$QStateTransTable [ ] [ ] = \{ \{ 0 , 1 \} , \{ 2 , 3 \} , \{ 1 , 0 \} , \{ 3 , 2 \} \}$$

There are three aspects that depend on the quantization state QState: (a) the mapping of transmitted transform coefficient levels to intermediate quantization indexes (part of the dequantization specified in the syntax); (b) the context selection for the sig_coeff_flag; (c) the derivation of the mapping parameter ZeroPos[ ] for transform coefficient levels coded in bypass mode. All three aspects are re-written in order to reflect the swapping of quantization states:
(a) The mapping of transmitted transform coefficient levels to intermediate quantization indexes (see syntax structure residual_coding( ) in VVC) is modified from

$$TransCoeffLevel [ x 0 ] [ y 0 ] [ cIdx ] [ xC ] [ yC ] = ( 2 * AbsLevel [ xC ] [ yC ] - ( QState > 1 ? 1 : 0 ) ) * ( 1 - 2 * coeff\_sign \_flag [ n ] )$$

to

$$TransCoeffLevel [ x 0 ] [ y 0 ] [ cIdx ] [ xC ] [ yC ] = ( 2 * AbsLevel [ xC ] [ yC ] - ( QState \& 1 ) ) * ( 1 - 2 * coeff\_sign \_flag [ n ] )$$

(b) The context selection of the sig_coeff_flag depends on a parameter (context set id) that is derived based on the quantization state. In VVC, this parameter is given by

$$Max ( 0 , QState - 1 )$$

With the relabelling of the quantization states, this parameter can be derived according to

$$ctxSetId [ QState \& 3 ] with ctxSetId [ ] = \{ 0 , 1 , 0 , 2 \}$$

It should be noted that for the 4-state version, the result of (QState & 3) is equal to QState.

The masking is only required for the 8-state version of dependent quantization.
(c) The derivation of the mapping parameter ZeroPos [ ] for transform coefficient levels coded in bypass mode is modified from

$$ZeroPos [ n ] = ( QState < 2 ? 1 : 2 ) ≪ cRiceParam$$

to

$$ZeroPos [ n ] = ( 1 + ( QState \& 1 ) ) ≪ cRiceParam$$

### Dequantization Offset

In JVET-AD0251, the Dequantization offset technique is provided to improve the reconstructed quality of the dequantized transform coefficients. It is assumed that the RDO based quantization such as Dependent Quantization (DQ) with Trellis Coded Quantization procedure (TCQ) is an unconstrained multi objective optimization problem that can be generalized with the following equation.

$${y}^{*} = {arg min}_{y} [ R ( y ) + λ D ( x , {Q}^{- 1} ( y ) ) ] \qquad ( 6 )$$

In this equation, x∈Rⁿ is the n length real numbered coefficient to be quantized, y∈Zⁿ is the quantization indices defined on discrete set of reconstruction points. Using any quantizer Q(⋅) and dequantizer function Q⁻¹(⋅), the indices and reconstruction can be obtained by y=Q(x) and \hat{x}=Q⁻¹(y) respectively. Here, function R(⋅) is the rate function of the indices and function D(⋅,⋅) is a distortion metric such as Mean Square Error (MSE).

Using KKT conditions on equation (6), it can be shown that if the solution found by RDO based quantization is optimal, the following condition should be met.

$${∇}_{y} ( R ( y ) ) = - λ {∇}_{y} ( D ( x , {Q}^{- 1} ( y ) ) ) \qquad ( 7 )$$

Of the first order gradient-based optimization methods, if the current solution takes a step to the negative direction of its gradient with respect to some objective function, this objective function gets smaller. For RDO based quantization case, if the quantization indices y are shifted by gradient with respect to distortion such as y←y−ρ∇_{y}(D(x, Q⁻¹(y))), where ρ∈R⁺ is step size, the distortion D(x, Q⁻¹(y)) gets smaller. However, it is not possible to know distortion without knowing original input data explicitly. The negative gradient with respect to rate is utilized as it is its gradient with respect to distortion. Thus, the present disclosure provides examples shift the quantization indices in the loop of encoder's dequantization and decoder's dequantization as follows.

$$y ← y + ρ {∇}_{y} ( R ( y ) ) \qquad ( 8 )$$

In some examples according to the present disclosure, some offset value may be added to the quantization indices (y) (or dequantized coefficient Q⁻¹(y)) which increases the rate. But since this added offset is during the dequantized stage, it has no effect on the rate but increases reconstruction quality in theory.

According to the present disclosure, a very simple proxy of rate prediction is utilized, in which each quantization indices are independent, and rate increases by absolute value of the coefficient as

$$R ( {y}_{i} ) ≅ a \vert {y}_{i} \vert + b \qquad ( 9 )$$

The offset is applied in the manner described as follow.

$$\{ \begin{matrix}{y}_{i} ← {y}_{i} + {ρ}^{*} & {y}_{i} > 0 \\ {y}_{i} ← {y}_{i} - {ρ}^{*} & {y}_{i} < 0 \\ {y}_{i} ← {y}_{i} & {y}_{i} = 0\end{matrix} , for i = 1 .. n \qquad ( 10 )$$

The present disclosure applies some offset to the quantization index that makes them far away from zero point. The amount of the offset ρ*∈R⁺ can be finetuned over a validation set and used as a universal value for all videos.

In practice, since quantization indices should be integer, the original reconstructed coefficient is first calculated by Q⁻¹(yᵢ)) and reconstructed value when the quantization indices is shifted 1 quantization index to the opposite direction to the zero center as Q⁻¹(y′ᵢ)) where y′ᵢ=yᵢ+(yᵢ>0? 1:−1). Then the weighted sum of Q⁻¹(yᵢ)) and Q⁻¹(y′ᵢ)) as the reconstructed coefficient is taken as follow.

$$\hat{x} = ( 982 * {Q}^{- 1} ( {y}_{i} ) + 42 * {Q}^{- 1} ( {{y}^{′}}_{i} ) ) ≫ 10 \qquad ( 11 )$$

In some examples, this shifting on reconstruction coefficient is done only if the quantization index is not zero.

Although the existing dequantization offset method provides some additional compression efficiency in the ECM, its design can still be further improved. For example, the following deficiencies that exist in the current dequantization offset design are identified in this disclosure. First, in the current dequantization offset method, the transition state of dependent quantization technique and the QP value are not taken into account, which may affect the performance of the dequantization offset.

Second, in the current dequantization offset method, the offset value is fixed for all the transform block (TB). However, the statistical characteristics of different TBs may vary significantly. Therefore, the fixed offset value makes it less effective.

In this disclosure, several methods are provided to further improve the compression efficiency of current dequantization offset method. The following embodiments may be applied independently or in combination.

### Transition State-Based Dequantization Offset

In one embodiment, it is provided to assign different offset values for different transition states in the DQ. Assume the transition state number of DQ is K. For each transition state s, a corresponding offset value ρₛ is utilized.

In one example, a look-up table is defined as Ω={ρ₀, ρ₁, . . . ρ_{K-1}}, ρᵢ∈R⁺, in which the element of each entry represents the offset value of the corresponding transition state. The offset is applied as follow.

$$\{ \begin{matrix}{y}_{i} ← {y}_{i} + {ρ}_{{s}_{i}} & {y}_{i} > 0 \\ {y}_{i} ← {y}_{i} - {ρ}_{{s}_{i}} & {y}_{i} < 0 \\ {y}_{i} ← {y}_{i} & {y}_{i} = 0\end{matrix} , for i = 1 .. n \qquad ( 12 )$$

where sᵢ represents the transition state for the i-th coefficient to be dequantized.

In another example, integer implementation of the transition state based dequantization offset method is provided. Firstly, two look-up tables with integer elements are defined as Ω={ρ₀, ρ₁, . . . ρ_{N-1}}, ρᵢ∈N⁺ and Ψ={ω₀, ω₁, . . . , ω_{N-1}}, ωᵢ∈N⁺, in which the element of each entry represents the offset value and weighting factor of the corresponding transition state, respectively. The dequantized transform coefficient is calculated as follow.

$$\hat{x} = ( ( {2}^{N} - {ω}_{{s}_{i}} ) * {Q}^{- 1} ( {y}_{i} ) + {ω}_{{s}_{i}} * {Q}^{- 1} ( {{y}^{′}}_{i} ) ) ≫ N \qquad ( 13 )$$

where the weighting factors are quantized and represented using N-bits.

### QP-Based Dequantization Offset

In one embodiment, it is provided to assign different offset values for different QP values. For each QP value, a corresponding offset value ρ(QP)∈R⁺ is utilized. The offset is applied as follow.

$$\{ \begin{matrix}{y}_{i} ← {y}_{i} + ρ ( QP ) & {y}_{i} > 0 \\ {y}_{i} ← {y}_{i} - ρ ( QP ) & {y}_{i} < 0 \\ {y}_{i} ← {y}_{i} & {y}_{i} = 0\end{matrix} , for i = 1 .. n \qquad ( 14 - 1 )$$

In one example, integer implementation of the QP based dequantization offset method is provided. Firstly, two look-up tables with integer elements are defined as Ω={ρ₀, ρ₁, . . . ρ_{K-1}}, ρᵢ∈N⁺ and Ψ={ω₀, ω₁, . . . , ω_{K-1}}, ωᵢ∈N⁺, in which the element of each entry represents the offset value and weighting factor of the corresponding QP, respectively. The offset is applied as follow.

$$\{ \begin{matrix}{y}_{i} ← {y}_{i} + {ρ}_{e ( QP )} & {y}_{i} > 0 \\ {y}_{i} ← {y}_{i} - {ρ}_{e ( QP )} & {y}_{i} < 0 \\ {y}_{i} ← {y}_{i} & {y}_{i} = 0\end{matrix} , for i = 1 .. n \qquad ( 14 - 2 )$$

where e(QP) represents the index for the corresponding QP. The dequantized transform coefficient is calculated as follow.

$$\hat{x} = ( ( {2}^{N} - {ω}_{e ( QP )} ) * {Q}^{- 1} ( {y}_{i} ) + {ω}_{e ( QP )} * {Q}^{- 1} ( {{y}^{′}}_{i} ) ) ≫ N \qquad ( 15 )$$

where the weighting factors are quantized and represented using N-bits.

### Quantization-Index-Based Dequantization Offset

In one embodiment, it is provided to assign different offset values to quantization indices according to their corresponding magnitudes. For each quantization index, a corresponding offset value ρ(|yᵢ|)∈R⁺ is utilized. The offset is applied as follow.

$$\{ \begin{matrix}{y}_{i} ← {y}_{i} + ρ ( \vert {y}_{i} \vert ) & {y}_{i} > 0 \\ {y}_{i} ← {y}_{i} - ρ ( \vert {y}_{i} \vert ) & {y}_{i} < 0 \\ {y}_{i} ← {y}_{i} & {y}_{i} = 0\end{matrix} , for i = 1 .. n \qquad ( 16 - 1 )$$

Additionally, when the above idea is applied, the dynamic range of the magnitude of the quantization index may be divided into several (e.g., M) segments and one specific offset value will be derived and added to the all the quantization indices that fall into one specific segment. In one example, integer implementation of the quantization index based dequantization offset method is provided. Firstly, two look-up tables with M integer elements are defined as Ω={ρ₀, ρ₁, . . . , ρ_{M-1}}, ρᵢ∈N⁺ and Ψ={ω₀, ω₁, . . . , ω_{M-1}}, ωᵢ∈N⁺, in which the element of each entry represents the offset value and weighting factor of the corresponding segment of the quantization indices, respectively. The offset is applied as follow.

$$\{ \begin{matrix}{y}_{i} ← {y}_{i} + {ρ}_{s ( \vert {y}_{i} \vert )} & {y}_{i} > 0 \\ {y}_{i} ← {y}_{i} - {ρ}_{s ( \vert {y}_{i} \vert )} & {y}_{i} < 0 \\ {y}_{i} ← {y}_{i} & {y}_{i} = 0\end{matrix} , for i = 1 .. n \qquad ( 16 - 2 )$$

where s(|yᵢ|) represents the index for the segment that the quantization index belongs to. The dequantized transform coefficient is calculated as follow.

$$\hat{x} = ( ( {2}^{N} - {ω}_{s ( \vert {y}_{i} \vert )} ) * {Q}^{- 1} ( {y}_{i} ) + {ω}_{s ( \vert {y}_{i} \vert )} * {Q}^{- 1} ( {{y}^{′}}_{i} ) ) ≫ N \qquad ( 17 )$$

where the weighting factors are quantized and represented using N-bits.

In the present disclosure, though being proposed independently, all the three methods of deriving the dequantization offsets (i.e., transition-state-based dequantization offset, QP-based dequantization and quantization index based dequantization offset) can be jointly applied in the proposed scheme. In one method, it is provided to use any two of the three methods to derive the corresponding dequantization offset in the proposed scheme. In another method, it is provided to apply all three methods to derive the corresponding dequantization offset.

### Adaptive Dequantization Offset

In one embodiment, it is provided to decide the dequantization offset values and weighting factors at the encoder side with rate-distortion optimization and signal the offset values and weighting factors to the decoder side. The offset values and weighting factors can be decided and signaled at picture/slice/CTU/CU/TU level.

In the first example, the dequantization offset values and weighting factors are derived at the encoder side for each picture/slice/CTU/CU/TU, and dequantization offset values and weighting factors values are applied and signaled at the picture/slice/CTU/CU/TU level.

In the second example, two look-up tables are defined for dequantization offset values and weighting factors, respectively. At the encoder side, the optimal dequantization offset values and weighting factors are decided with rate-distortion optimization for each picture/slice/CTU/CU/TU. The corresponding indices for the dequantization offset and weighting factor are signaled in the bitstream at the picture/slice/CTU/CU/TU level.

In another embodiment, it is provided to derive the dequantization offset values and weighting factors at the decoder side. The offset values and weighting factors can be derived at picture/slice/CTU/CU/TU level.

In the first example, the dequantization offset values and weighting factors are derived at the decoder side for each picture/slice/CTU/CU/TU, and applied at the same level.

In the second example, the dequantization offset values and weighting factors are inherited from the previously decoded pictures at the same temporal layer. For example, the dequantization offset values and weighting factors for the current CTU can be inherited from the collocated CTU in the previously decoded pictures at the same temporal layer. After current picture/slice/CTU/CU/TU is decoded, the corresponding dequantization offset values and weighting factors are updated and used for the pictures to be decoded in the future.

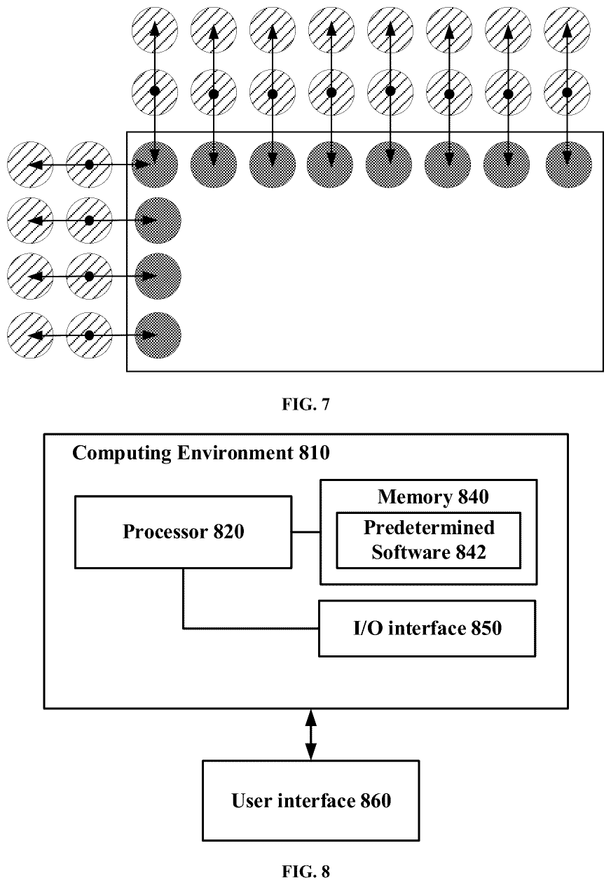

In another embodiment, one decoder-side dequantization offset derivation method is provided. In general, there is a high correlation among the samples at the boundaries between the current block and it neighboring blocks, which is utilized to select the best offset that is applied to the quantization coefficients in the current block. As shown in FIG. 7, it assumes there are M possible dequantization offset candidates. The method may apply each offset to the quantization indices of the block and generates the reconstructed samples at the top and left boundaries of the current block (which is also known as hypothesis); and then uses them to compare with extrapolated samples from neighboring blocks. The offset which minimizes such difference is selected as the offset to be applied.

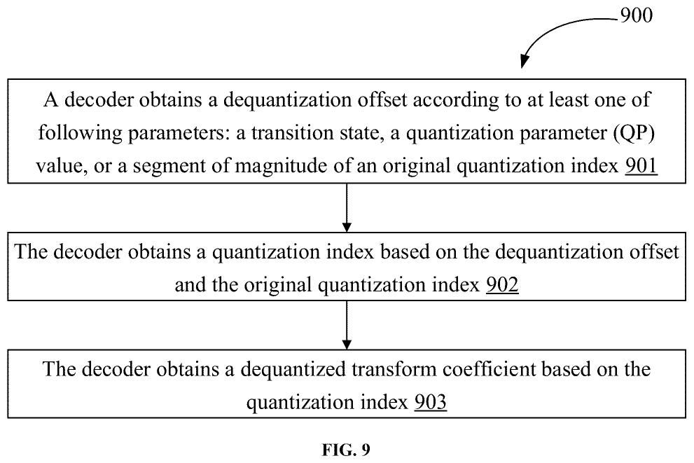

FIG. 8 shows a computing environment 810 coupled with a user interface 850. The computing environment 810 can be part of a data processing server. The computing environment 810 includes a processor 820, a memory 830, and an Input/Output (I/O) interface 840.

The processor 820 typically controls overall operations of the computing environment 810, such as the operations associated with display, data acquisition, data communications, and image processing. The processor 820 may include one or more processors to execute instructions to perform all or some of the steps in the above-described methods. Moreover, the processor 820 may include one or more modules that facilitate the interaction between the processor 820 and other components. The processor may be a Central Processing Unit (CPU), a microprocessor, a single chip machine, a Graphical Processing Unit (GPU), or the like.

The memory 830 is configured to store various types of data to support the operation of the computing environment 810. The memory 830 may include predetermined software 832. Examples of such data includes instructions for any applications or methods operated on the computing environment 810, video datasets, image data, etc. The memory 830 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 840 provides an interface between the processor 820 and peripheral interface modules, such as a keyboard, a click wheel, buttons, and the like. The buttons may include but are not limited to, a home button, a start scan button, and a stop scan button. The I/O interface 840 can be coupled with an encoder and decoder.

FIG. 9 is a flowchart illustrating a method for video decoding according to an example of the present disclosure.

In Step 901, the processor 820, at the side of a decoder, may obtain a dequantization offset according to at least one of following parameters: a transition state, a quantization parameter (QP), or a segment of magnitude of an original quantization index.

In some examples, the transition state is indicated by sᵢ for the i-th coefficient to be dequantized. The transition state may be a quantization state QState. The dequantization offset obtained according to the transition state may be represented as ρₛ_{ᵢ} as shown in equation (12).

In some examples, the dequantization offset obtained according to the QP may be represented as ρ(QP) as shown in equation (14-1). When e(QP) represents the index for the corresponding QP, the dequantization offset obtained according to the QP may be represented as ρ_{e(QP)} as shown in equation (14-2).

In some examples, the dequantization offset obtained according to the segment of magnitude of the original quantization index may be represented as ρ(|yᵢ|) as shown in equation (16-1). When s(|yᵢ|) represents the index for the segment that the quantization index belongs to, the dequantization offset obtained according to the segment of magnitude of the original quantization index may be represented as ρ_{s(|y}_{ᵢ}_{|)} as shown in equation (16-2).

In some examples, the processor 820 may obtain the dequantization offset according to the transition state by selecting the dequantization offset from a first offset look-up table based on the transition state corresponding to the dequantization offset, and where the first offset look-up table includes a plurality of offset values corresponding to a plurality of transition states. For example, the first offset look-up table may be the look-up table defined as Ω={ρ₀, ρ₁, . . . , ρ_{N-1}}, ρᵢ∈R⁺, as discussed in the section of “Transition State-based Dequantization Offset.”

In some examples, the processor 820 may obtain the dequantization offset according to the QP by selecting the dequantization offset from a second offset look-up table based on the QP corresponding to the dequantization offset, and the second offset look-up table includes a plurality of offset values corresponding to a plurality of QPs. For example, the second offset look-up table may be the look-up table defined as Ω={ρ₀, ρ₁, . . . , ρ_{K-1}}, ρᵢ ∈N⁺ as discussed in the section of “QP-based Dequantization Offset.”

In some examples, the magnitude of the original quantization index is divided into a plurality of segments, and all quantization indices in one segment have one offset value. The dequantization offset may have an offset value corresponding to the segment and the original quantization index is in the segment. The processor 820 may obtain the dequantization offset according to the segment of magnitude of the original quantization index by selecting the dequantization offset from a third offset look-up table based on the segment, and the third offset look-up table includes a plurality of offset values corresponding to the plurality of segments. For example, the third offset look-up table may be the look-up table defined as Ω={ρ₀, ρ₁, . . . ρ_{M-1}}, ρᵢ∈N⁺ as discussed in the section of “Quantization-index-based Dequantization Offset.”

For example, the dynamic range of the magnitude of the quantization index may be divided into several (e.g., M) segments and one specific offset value will be derived and added to the all the quantization indices that fall into one specific segment.

In some examples, the dequantization offset may be obtained by at least one of following steps: receiving the dequantization offset in a bitstream at a specific level; deriving the dequantization offset at a specific level; inheriting the dequantization offset from a previously decoded picture at a same temporal layer; or deriving the dequantization offset from one or more neighboring blocks of a current block.

In Step 902, the processor 820, at the side of the decoder, may obtain a quantization index based on the dequantization offset and the original quantization index, as shown in equation (12), (14-1), (14-2), (16-1), (16-2).

In Step 903, the processor 820, at the side of the decoder, may obtain a dequantized transform coefficient based on the quantization index.

In some examples, the processor 820 may obtain the dequantized transform coefficient based on the quantization index by obtaining a first dequantized coefficient based on the quantization index and obtaining a second dequantized coefficient based on a shifted quantization index. Further, the processor may obtain the dequantized transform coefficient by weighted-summing the first dequantized coefficient and the second dequantized coefficient.

In some examples, the processor 820 may obtain the dequantized transform coefficient by weighted-summing the first dequantized coefficient and the second dequantized coefficient based on a weighting factor.

In some examples of Transition State-based Dequantization Offset, the weighting factor @; may be selected from a first weight look-up table based on the transition state, the first weight look-up table includes a plurality of weighting factors corresponding to the plurality of transition states. For example, the weighting factor is w; selected form a look up table with integer elements Ψ={ω₀, ω₁, . . . , ω_{N-1}}, ωᵢ∈N⁺. Furthermore, the dequantization offset may be selected from the first offset look-up table, e.g., Ω={ρ₀, ρ₁, . . . , ρ_{N-1}}, ρᵢ∈N⁺, based on the transition state corresponding to the dequantization offset, and the first offset look-up table includes a plurality of offset values corresponding to the plurality of transition states.

For example, as shown in equation (13), the weighting factor may be ωᵢ, the first dequantized coefficient may correspond to Q⁻¹(yᵢ) that is based on the quantization index yᵢ and the second dequantized coefficient may correspond to Q⁻¹(y′ᵢ) that is based on the shifted quantization index y′ᵢ.

In some examples of QP-based Dequantization Offset, the weighting factor may be selected from a second weight look-up table based on the QP, and the second weight look-up table includes a plurality of weighting factors corresponding to the plurality of QPs, and the dequantization offset is selected from the second offset look-up table based on the QP corresponding to the dequantization offset, and the second offset look-up table includes a plurality of offset values corresponding to a plurality of QPs. For example, the second offset look-up table may be the look-up table Ω={ρ₀, ρ₁, . . . , ρ_{K-1}}, ρᵢ∈N⁺ and the second weight look-up table may be the look-up table Ψ={ω₀, ω₁, . . . , ω_{K-1}}, ωᵢ∈N⁺ in which the element of each entry represents the offset value and weighting factor of the corresponding QP, respectively.

For example, as shown in equation (15), the weighting factor may be ωᵢ, the first dequantized coefficient may correspond to Q⁻¹(yᵢ) that is based on the quantization index y; and the second dequantized coefficient may correspond to Q⁻¹(y′ᵢ) that is based on the shifted quantization index y′ᵢ.

In some examples of “Quantization-index-based Dequantization Offset,” the weighting factor may be selected from the third weight look-up table based on the segment, and the third weight look-up table includes a plurality of weighting factors corresponding to the plurality of segments. For example, the second offset look-up table may be the look-up table Ω={ρ₀, ρ₁, . . . , ρ_{M-1}}, ρᵢ∈N⁺ and the second weight look-up table may be the look-up table Ψ={ω₀, ω₁, . . . , ω_{M-1}}, ωᵢ∈N⁺ in which the element of each entry represents the offset value and weighting factor of the corresponding segment of the quantization indices, respectively.

For example, as shown in equation (17), the weighting factor may be ωᵢ, the first dequantized coefficient may correspond to Q⁻¹(yᵢ) that is based on the quantization index yᵢ and the second dequantized coefficient may correspond to Q⁻¹(y′ᵢ) that is based on the shifted quantization index y′ᵢ.

In some other examples, the weighting factor may be obtained by at least one of following steps: receiving the weighting factor in a bitstream at a specific level; deriving the weighting factor at a specific level; inheriting the weighting factor from a previously decoded picture at a same temporal layer; or deriving the weighting factor from one or more neighboring blocks of a current block.

In some other examples, the dequantized transform coefficient may be used to obtain a reconstructed sample.

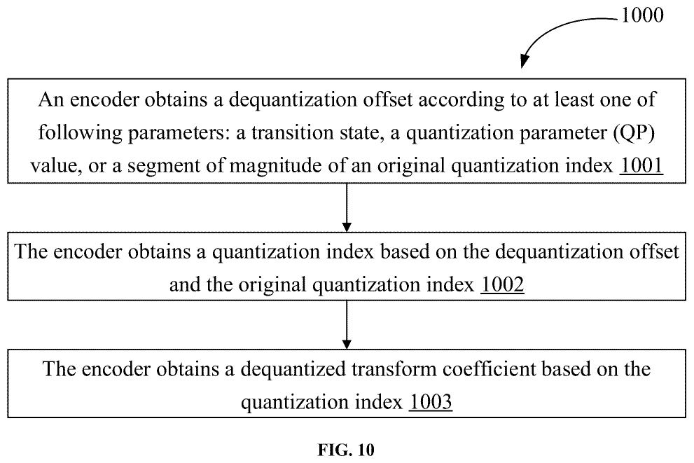

FIG. 10 is a flowchart illustrating a method for video encoding corresponding to the method for video decoding as shown in FIG. 9 in accordance with some examples of the present disclosure.

In Step 1001, the processor 820, at the side of an encoder, may obtain a dequantization offset according to at least one of following parameters: a transition state, a quantization parameter (QP), or a segment of magnitude of an original quantization index.

In some examples, the transition state is indicated by sᵢ for the i-th coefficient to be dequantized. The transition state may be a quantization state QState. The dequantization offset obtained according to the transition state may be represented as ρₛ_{ᵢ} as shown in equation (12).

In some examples, the dequantization offset obtained according to the QP may be represented as ρ(QP) as shown in equation (14-1). When e (QP) represents the index for the corresponding QP, the dequantization offset obtained according to the QP may be represented as ρ_{e(QP)} as shown in equation (14-2).

In some examples, the dequantization offset obtained according to the segment of magnitude of the original quantization index may be represented as ρ(|yᵢ|) as shown in equation (16-1). When s(|yᵢ|) represents the index for the segment that the quantization index belongs to, the dequantization offset obtained according to the segment of magnitude of the original quantization index may be represented as ρ_{s(|y}_{ᵢ}_{|)} as shown in equation (16-2).

In some examples, the processor 820 may obtain the dequantization offset according to the transition state by selecting the dequantization offset from a first offset look-up table based on the transition state corresponding to the dequantization offset, and where the first offset look-up table includes a plurality of offset values corresponding to a plurality of transition states. For example, the first offset look-up table may be the look-up table defined as Ω={ρ₀, ρ₁, . . . , ρ_{N-1}}, ρᵢ∈R⁺, as discussed in the section of “Transition State-based Dequantization Offset.”

In some examples, the processor 820 may obtain the dequantization offset according to the QP by selecting the dequantization offset from a second offset look-up table based on the QP corresponding to the dequantization offset, and the second offset look-up table includes a plurality of offset values corresponding to a plurality of QPs. For example, the second offset look-up table may be the look-up table defined as Ω={ρ₀, ρ₁, . . . , ρ_{K-1}}, ρᵢ∈N⁺ as discussed in the section of “QP-based Dequantization Offset.”

In some examples, the magnitude of the original quantization index is divided into a plurality of segments, and all quantization indices in one segment have one offset value. The dequantization offset may have an offset value corresponding to the segment and the original quantization index is in the segment. The processor 820 may obtain the dequantization offset according to the segment of magnitude of the original quantization index by selecting the dequantization offset from a third offset look-up table based on the segment, and the third offset look-up table includes a plurality of offset values corresponding to the plurality of segments. For example, the third offset look-up table may be the look-up table defined as Ω={ρ₀, ρ₁, . . . , ρ_{M-1}}, ρᵢ∈N⁺ as discussed in the section of “Quantization-index-based Dequantization Offset.”

For example, the dynamic range of the magnitude of the quantization index may be divided into several (e.g., M) segments and one specific offset value will be derived and added to the all the quantization indices that fall into one specific segment.

In some examples, the dequantization offset may be obtained by at least one of following steps: signaling the dequantization offset in a bitstream at a specific level; deriving the dequantization offset at a specific level; inheriting the dequantization offset from a previously decoded picture at a same temporal layer; or deriving the dequantization offset from one or more neighboring blocks of a current block.

In Step 1002, the processor 820, at the side of the encoder, may obtain a quantization index based on the dequantization offset and the original quantization index, as shown in equation (12), (14-1), (14-2), (16-1), (16-2).

In Step 1003, the processor 820, at the side of the encoder, may obtain a dequantized transform coefficient based on the quantization index.

In some other examples, the dequantized transform coefficient may be signaled in the bitstream. In some other examples, the dequantized transform coefficient may be used to obtain a reconstructed sample.

In some examples, the processor 820 may obtain the dequantized transform coefficient based on the quantization index by obtaining a first dequantized coefficient based on the quantization index and obtaining a second dequantized coefficient based on a shifted quantization index. Further, the processor may obtain the dequantized transform coefficient by weighted-summing the first dequantized coefficient and the second dequantized coefficient.

In some examples, the processor 820 may obtain the dequantized transform coefficient by weighted-summing the first dequantized coefficient and the second dequantized coefficient based on a weighting factor.

In some examples of Transition State-based Dequantization Offset, the weighting factor ωᵢ may be selected from a first weight look-up table based on the transition state, the first weight look-up table includes a plurality of weighting factors corresponding to the plurality of transition states. For example, the weighting factor is w; selected form a look up table with integer elements Ψ={ω₀, ω₁, . . . , ω_{N-1}}, ωᵢ∈N⁺. Furthermore, the dequantization offset may be selected from the first offset look-up table, e.g., Ω={ρ₀, ρ₁, . . . , ρ_{N-1}}, ρᵢ∈N⁺, based on the transition state corresponding to the dequantization offset, and the first offset look-up table includes a plurality of offset values corresponding to the plurality of transition states.

For example, as shown in equation (13), the weighting factor may be ωᵢ, the first dequantized coefficient may correspond to Q⁻¹(yᵢ) that is based on the quantization index yᵢ and the second dequantized coefficient may correspond to Q⁻¹(y′ᵢ) that is based on the shifted quantization index y′ᵢ.

In some examples of QP-based Dequantization Offset, the weighting factor may be selected from a second weight look-up table based on the QP, and the second weight look-up table includes a plurality of weighting factors corresponding to the plurality of QPs, and the dequantization offset is selected from the second offset look-up table based on the QP corresponding to the dequantization offset, and the second offset look-up table includes a plurality of offset values corresponding to a plurality of QPs. For example, the second offset look-up table may be the look-up table Ω={ρ₀, ρ₁, . . . , ρ_{K-1}}, ρᵢ∈N⁺ and the second weight look-up table may be the look-up table Ψ={ω₀, ω₁, . . . , ω_{K-1}}, ωᵢ∈N⁺ in which the element of each entry represents the offset value and weighting factor of the corresponding QP, respectively.

For example, as shown in equation (15), the weighting factor may be ωᵢ, the first dequantized coefficient may correspond to Q⁻¹(yᵢ) that is based on the quantization index y; and the second dequantized coefficient may correspond to Q⁻¹(y′ᵢ) that is based on the shifted quantization index y′ᵢ.

In some examples of “Quantization-index-based Dequantization Offset,” the weighting factor may be selected from the third weight look-up table based on the segment, and the third weight look-up table includes a plurality of weighting factors corresponding to the plurality of segments. For example, the second offset look-up table may be the look-up table Ω={ρ₀, ρ₁, . . . , ρ_{M-1}}, ρᵢ∈N⁺ and the second weight look-up table may be the look-up table Y′={ω₀, ω₁, . . . , ω_{M-1}}, ωᵢ∈N⁺ in which the element of each entry represents the offset value and weighting factor of the corresponding segment of the quantization indices, respectively.

For example, as shown in equation (17), the weighting factor may be ωᵢ, the first dequantized coefficient may correspond to Q⁻¹(yᵢ) that is based on the quantization index yᵢ and the second dequantized coefficient may correspond to Q⁻¹(y′ᵢ) that is based on the shifted quantization index y′ᵢ.

In some other examples, the weighting factor may be obtained by at least one of following steps: signaling the weighting factor in a bitstream at a specific level; deriving the weighting factor at a specific level; inheriting the weighting factor from a previously decoded picture at a same temporal layer; or deriving the weighting factor from one or more neighboring blocks of a current block.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

In an embodiment, there is also provided a non-transitory computer-readable storage medium comprising a plurality of programs, for example, in the memory 830, executable by the processor 820 in the computing environment 810, for performing the above-described methods and/or storing a bitstream generated by the encoding method described above or a bitstream to be decoded by the decoding method described above. In an embodiment, the plurality of programs may be executed by the processor 820 in the computing environment 810 to receive (for example, from the video encoder 20 in FIG. 2) a bitstream or data stream including encoded video information (for example, video blocks representing encoded video frames, and/or associated one or more syntax elements, etc.), and may also be executed by the processor 820 in the computing environment 810 to perform the decoding method described above according to the received bitstream or data stream. In another example, the plurality of programs may be executed by the processor 820 in the computing environment 810 to perform the encoding method described above to encode video information (for example, video blocks representing video frames, and/or associated one or more syntax elements, etc.) into a bitstream or data stream, and may also be executed by the processor 820 in the computing environment 810 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 820); and the non-transitory computer-readable storage medium or the memory 830 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 830, executable by the processor 820 in the computing environment 810, for performing the above-described methods. For example, the computer program product may include the non-transitory computer-readable storage medium.

In an embodiment, the computing environment 810 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings. Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for video decoding, comprising:
obtaining, by a decoder, a dequantization offset according to at least one of the following parameters: a transition state, a quantization parameter (QP), or a segment of magnitude of an original quantization index;
obtaining, by the decoder, a quantization index based on the dequantization offset and the original quantization index; and
obtaining, by the decoder, a dequantized transform coefficient based on the quantization index.

2. The method of claim 1, wherein obtaining the dequantization offset according to at least one of the following parameters: the transition state, the QP, or the segment of magnitude of the original quantization index comprises:
selecting the dequantization offset from a first offset look-up table based on the transition state corresponding to the dequantization offset, wherein the first offset look-up table comprises a plurality of offset values corresponding to a plurality of transition states.

3. The method of claim 1, wherein obtaining the dequantization offset according to at least one of the following parameters: the transition state, the QP, or the segment of magnitude of the original quantization index comprises:
selecting the dequantization offset from a second offset look-up table based on the QP corresponding to the dequantization offset, wherein the second offset look-up table comprises a plurality of offset values corresponding to a plurality of QPs.

4. The method of claim 1, wherein the magnitude of the original quantization index is divided into a plurality of segments, and all quantization indices in one segment have one offset value;
wherein the dequantization offset has an offset value corresponding to the segment and the original quantization index is in the segment; and
wherein obtaining the dequantization offset according to at least one of the following parameters: the transition state, the QP, or the segment of magnitude of the original quantization index comprises:
selecting the dequantization offset from a third offset look-up table based on the segment, and wherein the third offset look-up table comprises a plurality of offset values corresponding to the plurality of segments.

5. The method of claim 1, wherein obtaining the dequantized transform coefficient based on the quantization index comprises:
obtaining a first dequantized coefficient based on the quantization index;
obtaining a second dequantized coefficient based on a shifted quantization index; and
obtaining the dequantized transform coefficient by weighted-summing the first dequantized coefficient and the second dequantized coefficient.

6. The method of claim 5, wherein obtaining the dequantized transform coefficient by weighted-summing the first dequantized coefficient and the second dequantized coefficient comprises:
obtaining the dequantized transform coefficient by weighted-summing the first dequantized coefficient and the second dequantized coefficient based on a weighting factor, wherein the weighting factor is selected from a first weight look-up table based on the transition state, and the first weight look-up table comprises a plurality of weighting factors corresponding to a plurality of transition states.

7. The method of claim 5, wherein obtaining the dequantized transform coefficient by weighted-summing the first dequantized coefficient and the second dequantized coefficient comprises:
obtaining the dequantized transform coefficient by weighted-summing the first dequantized coefficient and the second dequantized coefficient based on a weighting factor, wherein the weighting factor is selected from a second weight look-up table based on the QP, and the second weight look-up table comprises a plurality of weighting factors corresponding to a plurality of QPs.

8. The method of claim 5, wherein obtaining the dequantized transform coefficient by weighted-summing the first dequantized coefficient and the second dequantized coefficient comprises:
obtaining the dequantized transform coefficient by weighted-summing the first dequantized coefficient and the second dequantized coefficient based on a weighting factor, wherein the weighting factor is selected from a third weight look-up table based on the segment, and the third weight look-up table comprises a plurality of weighting factors corresponding to a plurality of segments.

9. The method of claim 1, wherein obtaining the dequantization offset comprises at least one of the following steps:
receiving the dequantization offset in a bitstream at a specific level;
deriving the dequantization offset at a specific level;
inheriting the dequantization offset from a previously decoded picture at a same temporal layer; or
deriving the dequantization offset from one or more neighboring blocks of a current block.

10. The method of claim 5, wherein obtaining the dequantized transform coefficient by weighted-summing the first dequantized coefficient and the second dequantized coefficient comprises:
obtaining the dequantized transform coefficient by weighted-summing the first dequantized coefficient and the second dequantized coefficient based on a weighting factor, wherein the weighting factor is obtained by at least one of the following steps:
receiving the weighting factor in a bitstream at a specific level;
deriving the weighting factor at a specific level;
inheriting the weighting factor from a previously decoded picture at a same temporal layer; or
deriving the weighting factor from one or more neighboring blocks of a current block.

11. A method for video encoding, comprising:
obtaining, by an encoder, a dequantization offset according to at least one of the following parameters: a transition state, a quantization parameter (QP), or a segment of magnitude of an original quantization index;
obtaining, by the encoder, a quantization index based on the dequantization offset and the original quantization index; and
obtaining, by the encoder, a dequantized transform coefficient based on the quantization index.

12. The method of claim 11, wherein obtaining the dequantization offset according to at least one of the following parameters: the transition state, the QP, or the segment of magnitude of the original quantization index comprises:
selecting the dequantization offset from a first offset look-up table based on the transition state corresponding to the dequantization offset, wherein the first offset look-up table comprises a plurality of offset values corresponding to a plurality of transition states.

13. The method of claim 11, wherein obtaining the dequantization offset according to at least one of the following parameters: the transition state, the QP, or the segment of magnitude of the original quantization index comprises:
selecting the dequantization offset from a second offset look-up table based on the QP corresponding to the dequantization offset, wherein the second offset look-up table comprises a plurality of offset values corresponding to a plurality of QPs.

14. The method of claim 11, wherein the magnitude of the original quantization index is divided into a plurality of segments, and all quantization indices in one segment have one offset value;
wherein the dequantization offset has an offset value corresponding to the segment and the original quantization index is in the segment; and
wherein obtaining the dequantization offset according to at least one of the following parameters: the transition state, the QP, or the segment of magnitude of the original quantization index comprises:
selecting the dequantization offset from a third offset look-up table based on the segment, and wherein the third offset look-up table comprises a plurality of offset values corresponding to the plurality of segments.

15. The method of claim 11, wherein obtaining the dequantized transform coefficient based on the quantization index comprises:
obtaining a first dequantized coefficient based on the quantization index;
obtaining a second dequantized coefficient based on a shifted quantization index; and
obtaining the dequantized transform coefficient by weighted-summing the first dequantized coefficient and the second dequantized coefficient.

16. An apparatus for video decoding, comprising:
one or more processors; and
a memory coupled to the one or more processors and configured to store instructions executable by the one or more processors,
wherein the one or more processors, upon execution of the instructions, are configured to:
obtain a dequantization offset according to at least one of the following parameters: a transition state, a quantization parameter (QP), or a segment of magnitude of an original quantization index;
obtain a quantization index based on the dequantization offset and the original quantization index; and
obtain a dequantized transform coefficient based on the quantization index.

17. An apparatus for video encoding, comprising:
one or more processors; and
a memory coupled to the one or more processors and configured to store instructions executable by the one or more processors,
wherein the one or more processors, upon execution of the instructions, are configured to perform the method of claim 11.

18. A non-transitory computer-readable storage medium configured to store a bitstream to be decoded by the method of claim 1.

19. A non-transitory computer-readable storage medium configured to store a bitstream generated by the method of claim 11.

20. A method for storing a bitstream, comprising:
generating a bitstream by performing the method of claim 11; and
storing the bitstream.
